(19) United States
(12) Patent Application Publication
(10) Pub. No.: US 2009/0026345 A1
(43) Pub. Date: Jan. 29, 2009

(54) Electronic device shock-absorbing mounting system

(76) Inventors: Mark S. Tracy, Tomball, TX (US); Paul J. Doczy, Cypress, TX (US); Jonathan R. Harris, Cypress, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/880,788

(22) Filed: Jul. 24, 2007

(51) Int. Cl. F16M 13/00

(52) U.S. Cl. 248/615

(57) ABSTRACT

An electronic device shock-absorbing mounting system comprising at least one elastomeric shock-absorbing mount assembly coupling the at least one component of an electronic device to a housing of the electronic device.

### BACKGROUND OF THE INVENTION

Electronic devices generally contain one or more printed circuit boards (PCBs) hard mounted (screwed, bolted, etc.) inside a housing of the electronic device. Ball grid array (BGA) integrated circuits are common on the PCBs and include hundreds of solder joints mounted in a coplanar fashion on a PCB. However, shock and/or vibration experienced by the electronic device can cause the PCB to flex, thereby causing the solder joint to crack and fail.

### BRIEF DESCRIPTION OF THE DRAWINGS

FIG. 1 is a diagram illustrating an electronic device in which an embodiment of a shock-absorbing mounting system is employed to advantage; and

FIG. 2 is a diagram illustrating a section view of an elastomeric shock-absorbing mount assembly of the shock-absorbing mounting system of FIG. 1 taken along the line 2-2 of FIG. 1.

### DETAILED DESCRIPTION OF THE DRAWINGS

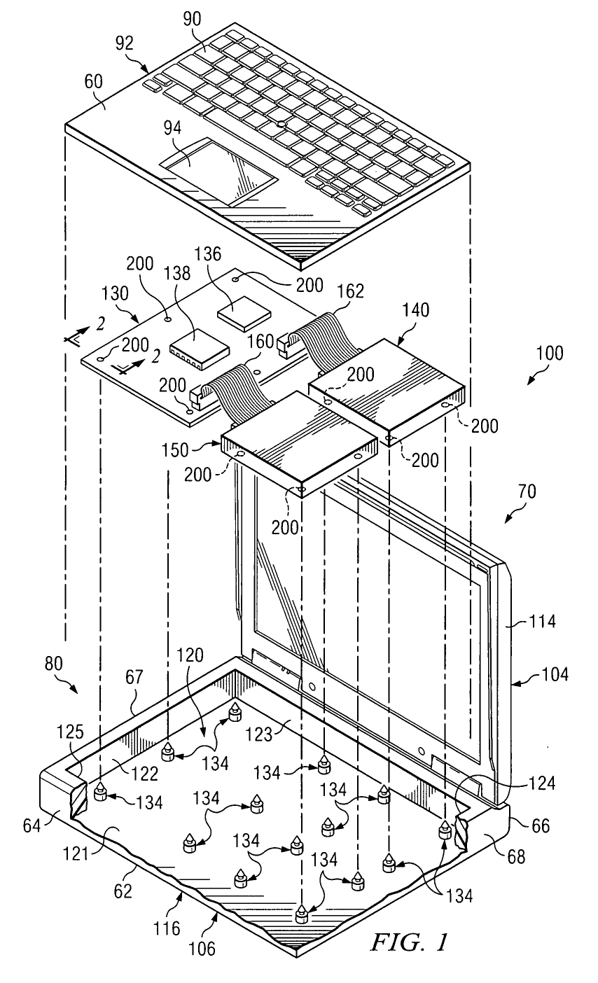

FIG. 1 is a diagram illustrating an electronic device 100 in which an embodiment of a shock-absorbing mounting system 80 is employed to advantage. In the illustrated embodiment, electronic device 100 is a laptop or notebook computer 70. However, it should be noted that electronic device 100 can be any type of portable and/or non-portable electronic device (e.g., desktop computer, a laptop computer, a tablet computer, a personal digital assistant (PDA), a cellular phone, a gaming device, etc.).

Electronic device 100 comprises a display member 104 rotatably coupled to a base member 106. Display member 104 and base member 106 each comprise a housing 114 and 116, respectively, for housing and/or supporting one or more components of electronic device 100. For example, in the illustrative embodiment, housing 116 comprises a top wall or working surface 60, a bottom wall 62, a front wall 64, a rear wall 66, and a pair of side walls 67 and 68. Working surface 60 comprises a support tray 92 for supporting a keyboard 90 and a touchpad 94. Support tray 92 can be seated along an edge and/or external lip of base member 106 and form working surface 60 of housing 116. Housing 116 comprises a cavity 120 which includes an internal bottom surface 121 and internal side surfaces 122, 123, 124, and 125. In the illustrated embodiment, cavity 120 houses a motherboard 130, an optical device 140, and a hard disk drive 150. It should be noted, however, that cavity 120 can comprise more and/or fewer and/or other types of components.

Mounting system 80 is configured to protect internal, electronic components from torsional and/or lateral vibrations and/or shock. In FIG. 1, mounting system 80 is employed in connection with motherboard 130, optical device 140, and hard disk drive 150. It should be noted, however, that mounting system 80 can also be used with other types of components (e.g., a video card, a graphics card, any other type of printed circuit board (PCB), a floppy drive, any other type of media device, etc.). In some embodiments, mounting system 80 comprises elastomeric shock-absorbing mount assemblies 134 and connectors 160 and 162. However, it should be understood that elastomeric shock-absorbing mount assemblies 134 may be used without connectors 160 and 162 and vice-versa. In the embodiment illustrated in FIG. 1, elastomeric shock-absorbing mount assemblies 134 are configured to be inserted through apertures 200 associated with and/or otherwise disposed on motherboard 130, optical device 140, and hard disk drive 150 to couple respective motherboard 130, optical device 140, and hard drive 150 to internal bottom surface 121 of base member 106. However, it should be understood that shock-absorbing mount assemblies 134 may be used to couple motherboard 130, optical device 140, and hard drive 150 to other portions of electronic device 100. Shock-absorbing mount assemblies 134 are configured to absorb and/or dissipate torsional and/or lateral vibrations, shock, and/or other type of shock events (e.g., resulting from electronic device 100 being dropped, twisted, etc.) and minimize stress on solder joints. For example, elastomeric shock-absorbing mount assemblies 134 create a standoff or gap between respective motherboard 130, optical drive 140, and hard drive 150 and internal bottom surface 121, thereby enabling motherboard 130, optical drive 140, and hard drive 150 to float above internal bottom surface 121. However, it should be understood that shock-absorbing mount assemblies 134 may be otherwise configured to shock-absorbingly couple a component to housing 116 (e.g., a c-shaped form configured to engage a side or edge of a component, fixedly attached to the component and insertable into openings formed in housing 116, etc.).

In the illustrated embodiment, a central processing unit (CPU) 136 and a memory component 138 are soldered to motherboard 130 at one or more solder joints (e.g., via ball grid array directly or through a socket). Shock-absorbing mount assemblies 134 are configured to absorb at least a portion of the vibration and/or shock experienced by electronic device 100, thereby enabling motherboard 130, optical drive 140, and hard drive 150 to move slightly in the direction of the vibration and/or shock. The movement of motherboard 130 reduces the amount of twisting and/or bending that may be experienced by motherboard 130, thereby reducing the amount of stress transmitted to one or more solder joints.

Each elastomeric shock-absorbing mount assembly 134 is configured to independently absorb and/or dissipate torsional and/or lateral vibrations and/or shock. Thus, the vibrations and/or shock received by one elastomeric shock-absorbing mount assembly 134 is not transmitted and/or shared with other elastomeric shock-absorbing mount assemblies 134. The independence of elastomeric shock-absorbing mount assemblies 134 also enables motherboard 130, optical device 140, and hard disk drive 150 to move independently of each other, thereby reducing the amount of stress and/or shock that each component (motherboard 130, optical device 140, and hard disk drive 150) experiences. It should be noted that elastomeric shock-absorbing mount assemblies 134 are not limited by the illustrated number, location and/or the positions. For example, a greater or fewer quantity of shock-absorbing mount assemblies 134 may be used in connection with motherboard 130, optical drive 140, and hard drive 150 and may be located at positions other than shown in FIG. 1.

In the illustrated embodiment, connectors 160 and 162 electrically and communicatively couple hard disk drive 150 and optical device 140, respectively, to motherboard 130. In some embodiments, connectors 160 and 162 are flexible cables configured to further enable optical device 140 and hard disk drive 150 to move independently of motherboard 130. Connectors 160 and 162 reduce or minimize at least a portion of the stress experienced by motherboard 130, optical device 140, and hard disk drive 150 by providing freedom of movement without tying the movement of any component to another component (e.g., hard mounting optical device 140 and hard disk drive 150 to motherboard 130). It should be noted, however, that connectors 160 and 162 may be any type of component (e.g., cable or any other type of electrical connecting device) that facilitates electrical communications between the various components within electronic device 100.

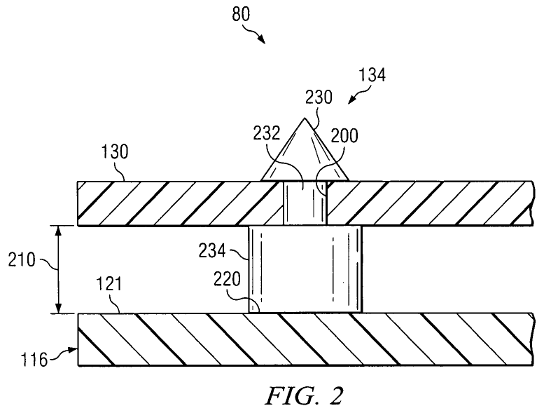

FIG. 2 is a diagram illustrating a section view of shock-absorbing mount assembly 134 of shock-absorbing mounting system 80 of FIG. 1 taken along the line 2-2 of FIG. 1. In FIG. 2, elastomeric shock-absorbing mount assembly 134 will be described in connection with motherboard 130; however, it should be understood that the component mounted using shock-absorbing mount assembly 134 may vary. Referring to FIG. 2, elastomeric shock-absorbing mount assemblies 134 is an elastomeric component that couples motherboard 130 to internal bottom surface 121 of electronic device 100. Elastomeric shock-absorbing mount assembly 134 can be made from any type of dampening material (e.g., silicone, thermoplastic urethane, thermoplastic elastomer, thermoplastic rubber, rubber, etc.). In the illustrated embodiment, elastomeric shock-absorbing mount assembly 134 comprises a head 230, a neck 232, and a body 234. In the illustrated embodiment, head 230 is configured to slide and/or be inserted through aperture 200 of motherboard 130 and secure elastomeric shock-absorbing mount assembly 134 to motherboard 130. When elastomeric shock-absorbing mount assembly 134 is secured to motherboard 130, neck 232 sits within aperture 200. Aperture 200 is an opening that enables elastomeric shock-absorbing mount assembly 134 to couple motherboard 130 to internal bottom surface 121.

Body 234 creates standoff or gap 210 between motherboard 130 and internal bottom surface 121, thereby enabling motherboard 130 to float above internal bottom surface 121. Body 234 may be coupled to internal bottom surface 121 at location 220 using any type of connection method. For example, body 234 may comprise a threaded end which screws into a threaded aperture at location 220 in internal bottom surface 121. Alternatively, body 234 may be adhesively or thermally bonded to location 220 of internal bottom surface 121. In yet another embodiment, body 234 may be molded into and/or press fit into internal bottom surface 121 at location 220. In FIG. 2, neck 232 is sized to correspond to a size of aperture 200 and sized smaller in cross-section than head 230 and body 234 to facilitate locating motherboard 130 a predetermined distance from internal bottom surface 121.

Elastomeric shock-absorbing mount assembly 134 also provides for improved alignment of motherboard 130 in housing 114 (FIG. 1). For example, the flexibility and/or deformability of elastomeric shock-absorbing mount assembly 134 enables elastomeric shock-absorbing mount assembly 134 to compensate for misalignment between a location of assembly 134 in housing 116 (or its mounting location 220) and a location of a corresponding aperture 200. Thus, embodiments of elastomeric shock-absorbing mount assemblies 134 decrease the precision required to couple motherboard 130 to internal bottom surface 121, thereby increasing the acceptable alignment tolerances for installation of motherboard 130 in housing 116 (FIG. 1) and absorbing stresses that may be otherwise caused by misalignment of attachment locations.

Thus, embodiments of shock-absorbing mounting system 80 may be manufactured by flexibly and/or shock-absorbingly mounting at least one component (e.g., motherboard 130, optical drive 140, and hard disk drive 150) to a housing (e.g., housing 116) of electronic device 100 using at least one elastomeric shock-absorbing mount assembly 134. The electronic device may also be manufactured by forming a shock-absorbing standoff between the component and the housing the elastomeric shock-absorbing mount assemblies. The electronic device may also be manufactured by inserting at least one elastomeric shock-absorbing mount assembly through at least one aperture of the component. The electronic device may also be manufactured by securing at least one elastomeric shock-absorbing mount assembly to a component by sliding a head of the elastomeric shock assembly through at least one aperture of the component. The electronic device may also be manufactured by coupling an electronic component to another component in the electronic device such that the electronic component is configured to absorb shock independently of the other component. The electronic device may also be manufactured by flexibly coupling the electronic component to another component to enable independent sock-absorbing movement.

Thus, embodiments of shock-absorbing mounting system 80 reduce the likelihood of cracked solder joints due to shock and/or vibration experienced by electronic device 100. Shock-absorbing mounting system 80 also provides for improved installation of and increased acceptable alignment tolerances for a printed circuit board (e.g., motherboard 130) in the housing (e.g., housing 116) of an electronic device (e.g., computer 70). Shock-absorbing mount assemblies 134 also enable a ready installation and removal of a component relative to a housing due to the elastomeric, flexible, and/or deformable nature of shock-absorbing mount assemblies 134.

What is claimed is:

1. An electronic device shock-absorbing mounting system, comprising:
at least one elastomeric shock-absorbing mount assembly coupling at least one component of an electronic device to a housing of the electronic device.

2. The system of claim 1, wherein the at least one elastomeric shock-absorbing mount assembly forms a shock-absorbing standoff between the at least one component and the housing.

3. The system of claim 1, wherein the at least one elastomeric shock-absorbing mount assembly is configured to be inserted through at least one aperture of the at least one component.

4. The system of claim 1, wherein the at least one component is secured between a head and a body of the at least one elastomeric shock-absorbing mount assembly.

5. The system of claim 1, wherein the at least one elastomeric shock-absorbing mount assembly is configured to enable movement of the at least one component independently of another component disposed in the housing and coupled to the at least one component.

6. The system of claim 1, further comprising flexibly coupling at least one other component to the at least one component to enable independent shock-absorbing movement of the at least one other component relative to the at least one component.

7. A method of manufacturing an electronic device shock-absorbing mounting system, comprising:
mounting at least one component of an electronic device to a housing of the electronic device using at least one elastomeric shock-absorbing mount assembly.

8. The method of claim 7, further comprising forming a shock-absorbing standoff between the at least one component and the housing the at least one elastomeric shock-absorbing mount assembly.

9. The method of claim 7, further comprising inserting the at least one elastomeric shock-absorbing mount assembly through at least one aperture of the at least one component.

10. The method of claim 7, further comprising securing the at least one component between a head and a body of the at least one elastomeric shock-absorbing mount assembly.

11. The method of claim 7, further comprising coupling the at least one component to one other component, the at least one elastomeric shock-absorbing mount assembly configured to enable movement of the at least one component independently of the one other component.

12. The method of claim 7, further comprising flexibly coupling at least one other component to the at least one component to enable independent shock-absorbing movement of the at least one other component relative to the at least one component.

13. An electronic device shock-absorbing mounting system, comprising:
a plurality of components coupled to each other, the plurality of components each coupled to a housing wall of an electronic device to enable shock-absorbing movement of the plurality of components independently of each other.

14. The system of claim 13, further comprising a plurality of elastomeric shock-absorbing mount assemblies coupling the plurality of components to the housing wall.

15. The system of claim 13, further comprising a plurality of elastomeric shock-absorbing mount assemblies forming a shock-absorbing standoff between the plurality of components and the housing.

16. The system of claim 13, further comprising a plurality of elastomeric shock-absorbing mount assemblies coupling the plurality of components to the housing wall and each configured to be inserted through an aperture of the respective plurality of components.

17. The system of claim 13, further comprising a plurality of elastomeric shock-absorbing mount assemblies configured to secure the plurality of components between a head and a body of the a plurality of elastomeric shock-absorbing mount assemblies.
